(19) United States
(12) Patent Application Publication
(10) Pub. No.: US 2013/0100296 A1
(43) Pub. Date: Apr. 25, 2013

(54) MEDIA CONTENT DISTRIBUTION

(71) Applicants: Feng Tang, Mountain View, CA (US); Daniel R. Tretter, San Jose, CA (US); Qian Lin, Santa Clara, CA (US)

(72) Inventors: Feng Tang, Mountain View, CA (US); Daniel R. Tretter, San Jose, CA (US); Qian Lin, Santa Clara, CA (US)

(21) Appl. No.: 13/300,529

(22) Filed: Nov. 18, 2011

Related U.S. Application Data
(63) Continuation-in-part of application No. 13/279,940, filed on Oct. 24, 2011.

(51) Int. Cl. H04N 5/225; G06F 17/30

(52) U.S. Cl. 348/207.1; 707/741; 707/E17.002; 707/E17.019; 348/E05.024

(57) ABSTRACT

A method of distributing media content includes capturing an image of a static media content, detecting at least one feature in the image, seeking a correlation of the image to a reference image using the at least one feature, and identifying at least one region of dynamic media content of the reference image in the image of the static media content.

### CROSS-REFERENCE TO RELATED APPLICATIONS

This application is a Continuation-In-Part of copending U.S. patent application Ser. No. 13/279,940, filed on Oct. 24, 2011, which is incorporated herein by reference.

### BACKGROUND

Recently, more and more users are creating and consuming rich media such as audio, video, and animation. While a user can augment on-line content by embedding rich media in content such as web pages, the user has traditionally been unable to augment print content (i.e., static, planar prints) with rich media once the content has been printed.

### BRIEF DESCRIPTION OF THE DRAWINGS

FIG. 1 is a block diagram illustrating an example of a dynamic media content distribution system.

FIG. 2 is a block diagram illustrating an example of dynamic media content distribution with the dynamic media content distribution system of FIG. 1.

FIG. 3 illustrates an example of a reference image.

FIG. 4A illustrates an example of identifying regions of dynamic media content in a captured image, and FIG. 4B illustrates an example of providing dynamic media content for at least one of the regions.

FIGS. 5A and 5B are flow diagrams illustrating an example of a method of dynamic media content distribution.

FIGS. 6A and 6B are flow diagrams illustrating an example of a method of dynamic media content distribution.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

As used herein, the term “includes” means includes but not limited to, the term “including” means including but not limited to. The term “based on” means based at least in part on.

The present disclosure provides methods and systems for augmenting rich media into static, planar printed material by using image recognition and interactive regions (i.e., “hotspots”) of the printed material which are linked to rich media content such as audio, video, or a URL. As illustrated and described herein, by viewing (i.e., imaging) the printed material through a mobile device, the printed material is automatically recognized, and the interactive regions of the printed material are “highlighted” in the viewing. As such, a user can interactively select (e.g., touch or click) regions of interest, and link to additional content. Such interaction has the potential of providing an enhanced level of personalization and improved user experience, thereby ultimately enhancing the value of printed material. The methods and systems illustrated and described herein may be applicable to numerous print products such as magazines, marketing collateral, wall paper recognition, and photobooks with applications such as music walls and clickable brochures.

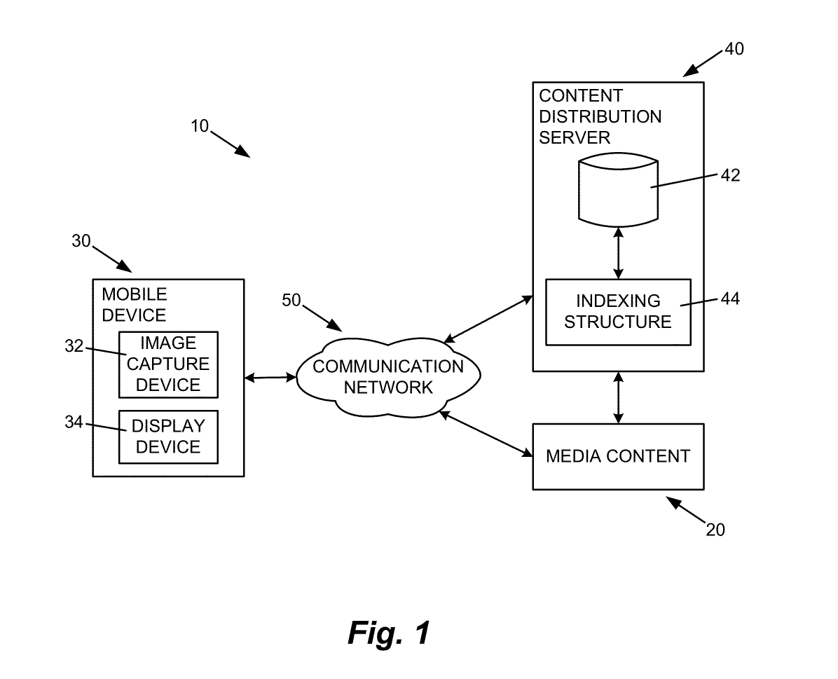

FIG. 1 is a block diagram illustrating one example of a dynamic media content distribution system 10, referred to hereafter as content distribution system 10. Content distribution system 10 facilitates active or dynamic distribution of content, such as media content 20, to one or more computing devices, such as mobile device 30. In one example, content distribution system 10 includes a content distribution server 40 communicated with mobile device 30 via a communication network 50. As such, content distribution server 40 facilitates distribution of media content 20 to mobile device 30 via communication network 50, as described below.

Media content 20, as used herein, is defined to include dynamic media content such as audio, video, graphics (including animations and 3-D models), and/or a uniform or universal resource locator (URL) to an Internet source of further media content. As such, media content 20 may provide augmented content and/or user rich media for a user of mobile device 30.

Mobile device 30, as used herein, is defined to include a cellular telephone, a person digital assistant (PDA), or other smartphone-type device, as well as a portable or tablet computer or computing device. In one example, mobile device 30 includes an image capture device 32, such as a digital camera, and a display device 34, including a touchscreen display. Mobile device 30 also includes a memory and a processor, with associated hardware and/or machine readable instructions (including firmware and/or software), for implementing and/or executing computer-readable, computer-executable instructions for data processing functions and/or functionality.

In one example, content distribution server 40 includes a database 42 of reference images, as further described below, and an indexing structure 44 interacting with database 42 and facilitating distribution of media content 20 to mobile device 30, as further described below. Content distribution server 40, including indexing structure 44 as a component of content distribution server 40, includes a memory and a processor, with associated hardware and/or machine readable instructions (including firmware and/or software), for implementing and/or executing computer-readable, computer-executable instructions for data processing functions and/or functionality.

In one example, a program including content distribution instructions accessible and executable by the processor of content distribution server 40 is stored in a non-transitory storage medium that may be integral to content distribution server 40 or may be located remotely and accessible, for example, over a network. Storage media suitable for tangibly embodying program instructions and data include all forms of computer-readable memory including, for example, RAM, semiconductor memory devices, such as EPROM, EEPROM, and flash memory devices, magnetic disks such as internal hard disks and removable hard disks, magneto-optical disks, DVD-ROM/RAM, and CD-ROM/RAM, among others.

Communication network 50, as used herein, is defined to include a local-area network (LAN) and/or a wide-area network (WAN). Communication network 50, therefore, may include an intranet communication network, an Internet communication network, or a similar high-speed communication network including a wireless communication network.

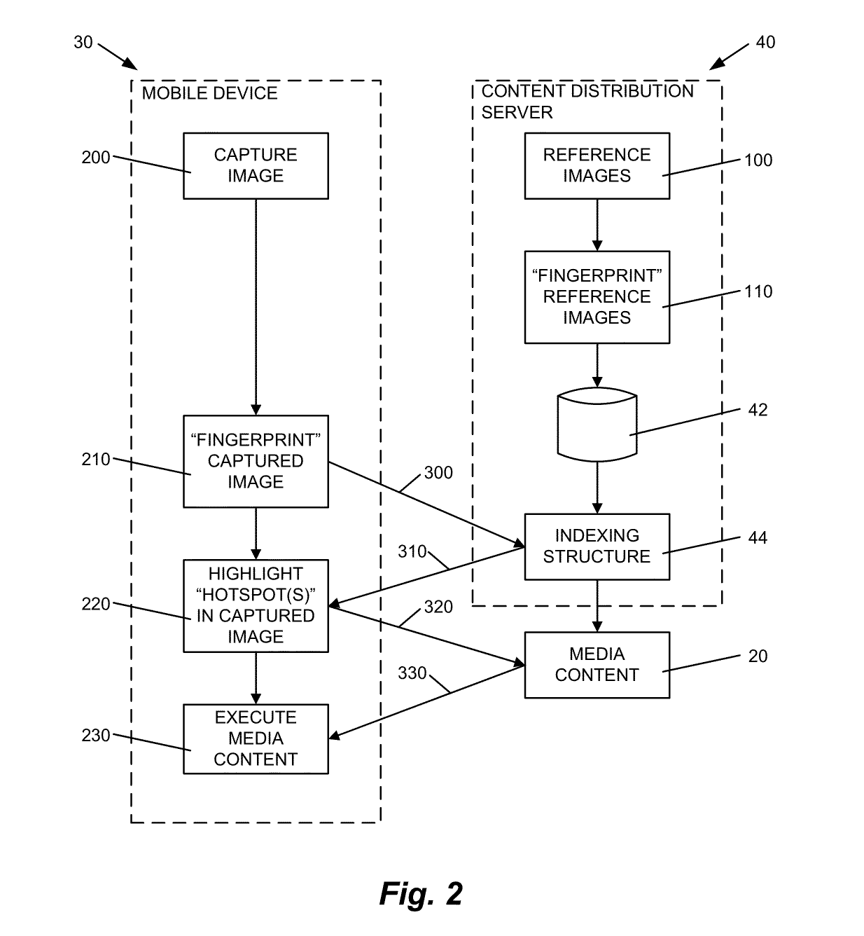

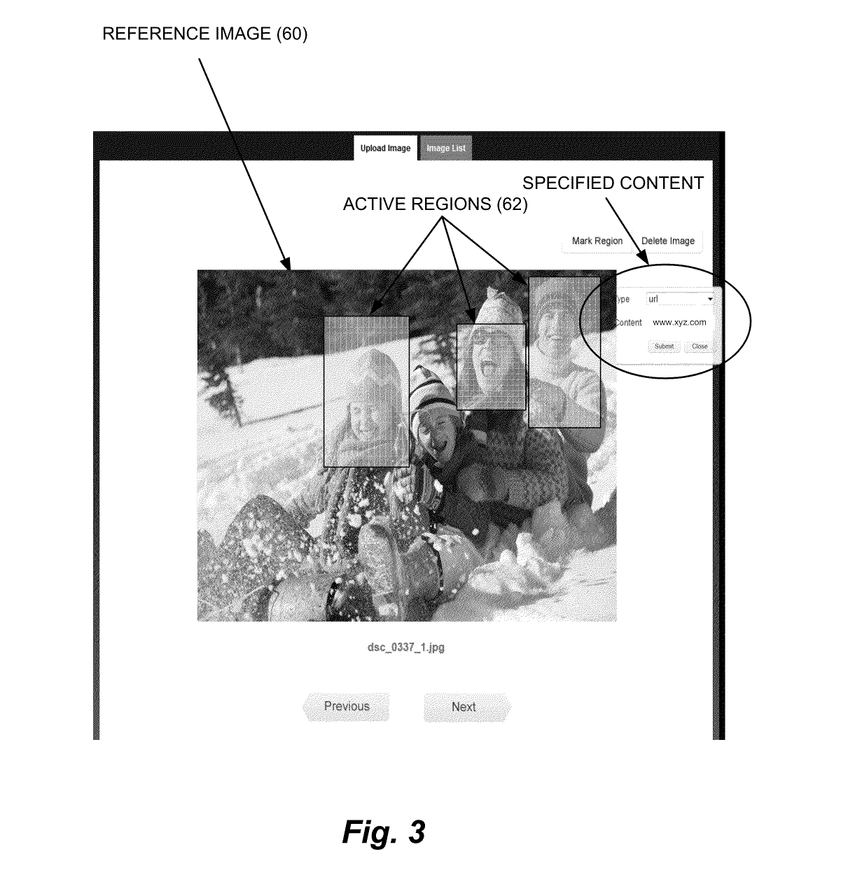

FIG. 2 is block diagram illustrating one example of content distribution with content distribution system 10 (FIG. 1). At 100, one or more reference images 60 (FIG. 3) are provided to content distribution server 40. As illustrated in the example of FIG. 3, reference image 60 includes one or more active or dynamic regions 62. Active or dynamic regions 62 are predefined to include corresponding media content 20 including, more specifically, reference to corresponding media content 20.

In one example, reference images 60 are provided via an online authoring portal whereby content providers and/or users upload, for example, one or more images or photographs to database 42, and specify one or more active or dynamic regions 62 of or within the images or photographs. As such, media content, such as media content 20, is specified or associated with one or more active or dynamic regions 62, including individually or grouped together, by, for example, the content provider or user such that media content 20 becomes dynamic media content for the respective image or photograph. As described above, media content 20, as associated with active or dynamic regions 62, may include, for example, audio, video, and/or a URL to an Internet source.

Returning to FIG. 2, at 110, in one example, reference images 60 are “fingerprinted.” More specifically, one or more features or feature descriptors are established for and associated with reference images 60. Example methods, devices, and systems for determining feature descriptors for an image (i.e., detecting and describing features of an image), such as reference images 60, are described in copending, and above-referenced, U.S. patent application Ser. No. 13/279,940, filed on Oct. 24, 2011, which is incorporated herein by reference. By “fingerprinting” or defining/associating one or more features or feature descriptors with reference images 60, correlating or matching of an image with a reference image 60 is enabled, as described below.

As used herein, correlating or correlation of an image with a reference image 60 includes a match between or a matching of an image with a reference image 60. As described below, matching of features or feature descriptors of images and, therefore, matching of images themselves, may be established by calculations resulting in values (e.g., Hamming distances) used for comparison in an effort to quantify a correspondence or relationship between images as being, for example, “better” or “likely.” As such, use of the terms “correlate,” “correlating,” and “correlation” include varying levels of match or matching.

Accordingly, with one or more active or dynamic regions 62 specified or defined for an image, with media content 20 specified for or associated with the one or more active or dynamic regions 62, and with one or more feature descriptors associated with the image, reference images 60 are stored in database 42 and accessible by indexing structure 44 for distribution of media content 20 to mobile device 30, as further described below.

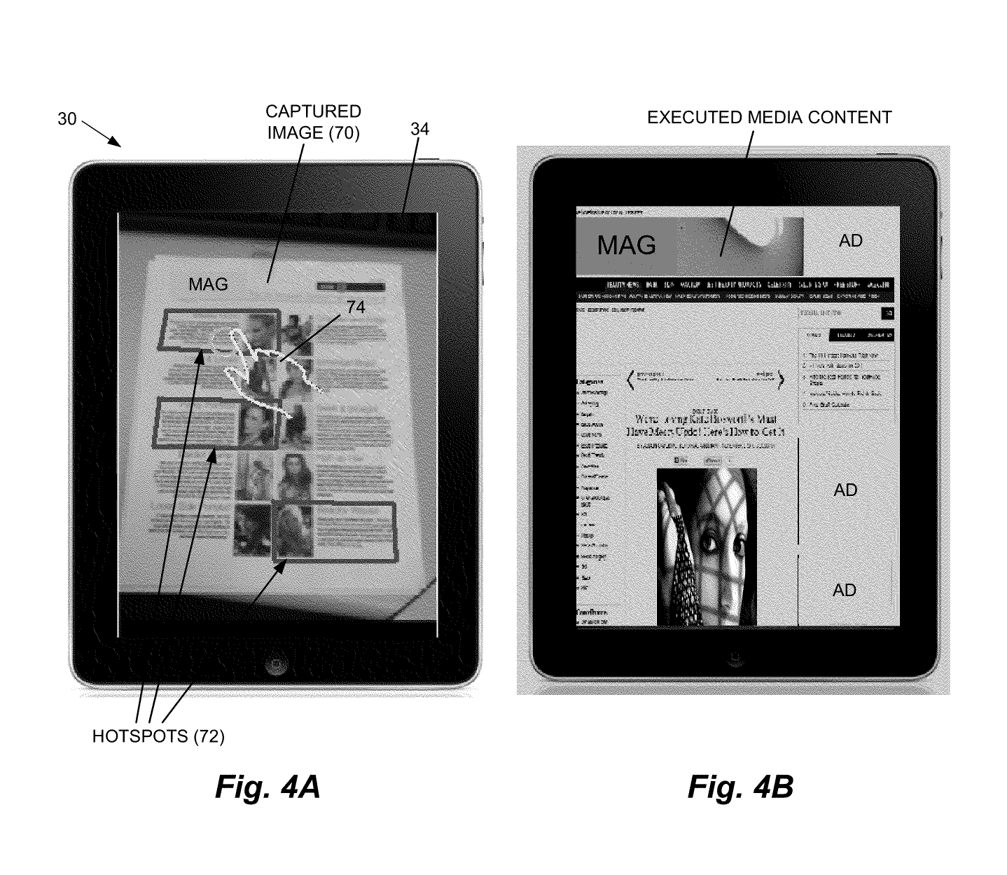

With reference images 60 stored in database 42, content distribution with content distribution system 10 continues at 200, where an image 70 of static media content is captured with mobile device 30. Static media content may include, for example, text, a photograph, an illustration, a still image, and/or a video frame. An image of such static media content is captured, for example, by image capture device 32 of mobile device 30. More specifically, a picture or digital image of static media content (e.g., a picture of printed material, a picture of a photograph, etc) is captured with image capture device 32 (i.e., digital camera) of mobile device 30. In one example, captured image 70 of static media content is displayed with display device 34 of mobile device 30 (see, e.g., FIG. 4A).

At 210, in one example, captured image 70 is “fingerprinted.” More specifically, and similar to that described above with reference to 110 and reference images 60, one or more features or feature descriptors are established for and associated with captured image 70. Similar to that described above, example methods, devices, and systems for determining feature descriptors for an image (i.e., detecting and describing features of an image), such as captured image 70, are described in copending, and above-referenced, U.S. patent application Ser. No. 13/279,940, filed on Oct. 24, 2011, which is incorporated herein by reference. By “fingerprinting” or defining/associating one or more features or feature descriptors with captured image 70, correlating or matching of captured image 70 with a reference image 60 may be performed, as described below.

In one example, correlating or matching of captured image 70 with reference image 60 is performed by indexing structure 44 of content distribution server 40. More specifically, in one example, to facilitate correlating or matching of captured image 70 with a reference image 60, and as represented by arrow 300 in FIG. 2, one or more features or feature descriptors of captured image 70 are communicated to content distribution server 40 including, more specifically, indexing structure 44 of content distribution server 40. As such, indexing structure 44 compares features or feature descriptors of captured image 70 with features or feature descriptors of reference images 60 to determine and identify a correlation or match of captured image 70 with a reference image 60. Example methods, devices, and systems for determining a correlation or match between images, such as reference images 60 and captured image 70, using features or feature descriptors of the images are described in copending, and above-referenced, U.S. patent application Ser. No. 13/279,940, filed on Oct. 24, 2011, which is incorporated herein by reference.

For example, a method of determining feature descriptors for images having a plurality of pixels includes defining a plurality of anchor points within a patch of pixels in a particular area that includes a detected feature in a first image, and defining a first set of subpatches, where each of the plurality of anchor points is included in a subpatch of pixels, and calculating an intensity of each of the first set of subpatches. The method includes defining a second set of subpatches that divides the patch of pixels in the particular area that includes the detected feature into a plurality of subpatches of pixels and calculating an intensity of each of the second set of subpatches. The intensity of each of the second set of subpatches is compared to the intensity of each of the first set of subpatches and if the intensity of a second set subpatch is higher than the intensity of a first set subpatch a binary value (e.g., the value of 1) is assigned, otherwise the alternative binary value (e.g., the value of 0) is assigned. Accordingly, a particular binary feature descriptor is determined by concatenating all the assigned binary values.

Accordingly, correlating or matching a first detected feature in a first image with a second detected feature in a second image, where the second detected feature has a second binary feature descriptor determined consistent with the method used to determine a first binary feature descriptor for the first image, can be performed. The consistency of such a calculation can include defining in the same positions as in the first image a plurality of anchor points within a patch of pixels in a particular area in the second image that includes the second detected feature. In some examples, correlating or matching the first detected feature in the first image with the second detected feature in the second image can include determining a Hamming distance between the first binary feature descriptor and the second binary feature descriptor, where a small Hamming distance indicates a better correlation or match between the first detected feature and the second detected feature than a larger Hamming distance.

For example, after a feature descriptor has been determined for a feature in one image, the feature descriptor can be correlated or matched to another feature descriptor determined for a detected feature in another image. In some examples, a processor (e.g., a computation module) can be used to execute instructions stored in memory for this correlating or matching process to compute the distance between the two descriptors to identify whether the two features are likely the same feature or whether the two features are likely different features. A smaller distance indicates that the two features are more similar and that the two features are a potential correlation or match.

Because the feature descriptors are sequences of 0s and 1s, the Hamming distance can be calculated for comparison. The Hamming distance d(x,y) between two vectors x, y is the number of coefficients by which the two vectors differ. For example, d(00111, 11001)=4. This can be efficiently implemented by using XOR operator on the feature descriptor (e.g., counting the number of bits that are different). In some examples, the system can include a correlating or matching module (not shown) with access to a processor to determine homography between the features detected in the first image and the features detected in the second image by comparison of the first binary feature descriptor with the second binary feature descriptor.

Correlating or matching the first detected feature in the first image to the second detected feature in the second image can, in various examples, include enabling a function selected from a group that includes: correlating or matching a number of features of a particular image with a number of features of a plurality of images saved in a database to determining potential correlations or matches to a number of particular images; and correlating or matching a number of features of a print image with a number of features of a plurality of dynamic media presentations saved in a database to enable video or audio play of a correlated or matched dynamic media presentation, as further described below.

With a correlation or match of captured image 70 to a reference image 60 determined, content distribution server 40, including, more specifically, indexing structure 44, identifies active or dynamic regions 62 of reference image 60. As such, and as represented by arrow 310 in FIG. 2, indexing structure 44 communicates (i.e., returns) identification of active or dynamic regions 62 to mobile device 30. In one example, indexing structure 44 returns a location of active or dynamic regions 62 of reference image 60 to mobile device 30.

At 220, active or dynamic regions 62 from reference image 60 are identified in captured image 70 while captured image 70 is displayed by mobile device 30. More specifically, and as illustrated in the example of FIG. 4A, active or dynamic regions 62 from reference image 60 are highlighted as “hotspots” 72 in captured image 70 as displayed on display device 34 of mobile device 30. In one example, hotspots 72 of captured image 70 are outlined or framed in captured image 70 with open quadrilaterals (i.e., boxes).

In one example, selection of one or more hotspots 72, as represented by outlined hand 74 in FIG. 4A, initiates retrieval and/or execution of media content 20. In one example, as represented by arrow 320 in FIG. 2, selection of one or more hotspots 72 is communicated to a source of media content 20 and, as represented by arrow 330 in FIG. 2, media content 20 as associated with the selected hotspot 72 is communicated (i.e. returned) to mobile device 30. Accordingly, at 230, media content 20 is executed by mobile device 30. Execution of media content 20 includes, for example, playback of media content 20 (e.g., if media content 20 is audio or video) and/or a redirect to additional media content (e.g., if media content 20 is a URL). For example, as illustrated in FIG. 4B, execution of media content 20 results in a redirect of mobile device 30 to additional media content (e.g., additional online information for a “teaser” article from a magazine originally presented in print form).

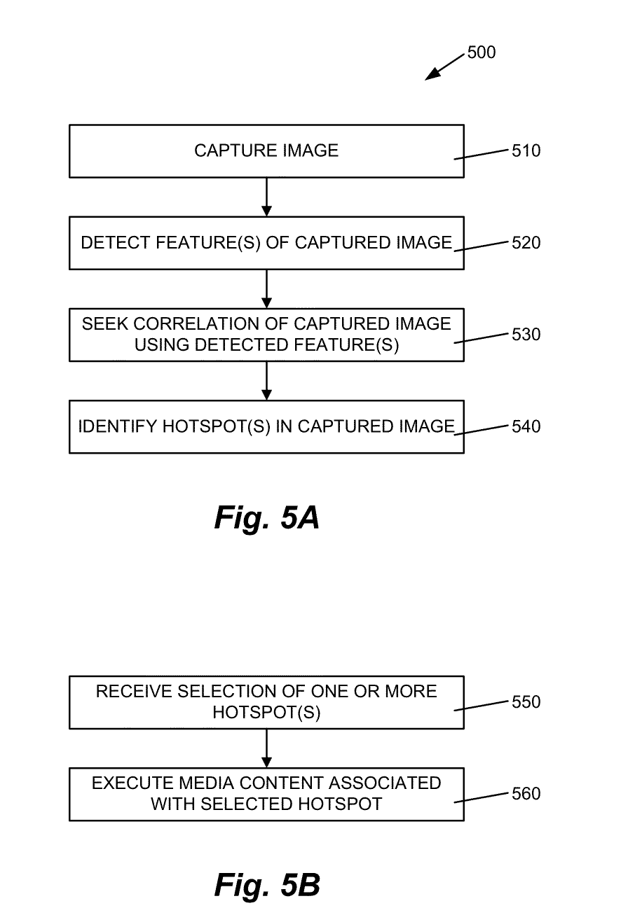

FIGS. 5A and 5B are flow diagrams illustrating one example of a method 500 of distributing media content 20. Method 500 represents one example of dynamic media content distribution with content distribution system 10, including interactions from a perspective of mobile device 30.

With reference to FIG. 5A, at 510, an image of static media content is captured, for example, with image capture device 32 of mobile device 30. As such, at 520, one or more features of captured image 70 are detected, and at 530, a correlation or match between captured image 70 and a reference image 60 is sought using, for example, the detected features of captured image 70.

Next, at 540, with a correlation or match of captured image 70 to a reference image 60 detected, active or dynamic regions 62 of reference image 60 are identified in captured image 70. In one example, as described above, active or dynamic regions 62 of reference image 60 are identified in captured image 70 as hotspots 72 such that hotspots 72 are displayed with display of captured image 70 by mobile device 30.

With reference to FIG. 5B, at 550, with hotspots 72 displayed with captured image 70 on mobile device 30, selection of one or more hotspots 72 is received. Selection of one or more hotspots 72 is performed, for example, by a user of mobile device 30, and includes, for example, a touch of hotspot 72 on display device 34 of mobile device 30. In one example, a homography matrix maps a point of user touch on captured image 70 to a corresponding point of reference image 60. As such, an area of user touch, and the associated media content, can be identified. Accordingly, at 560, media content 20, as associated with the selected hotspot 72, is executed on mobile device 30.

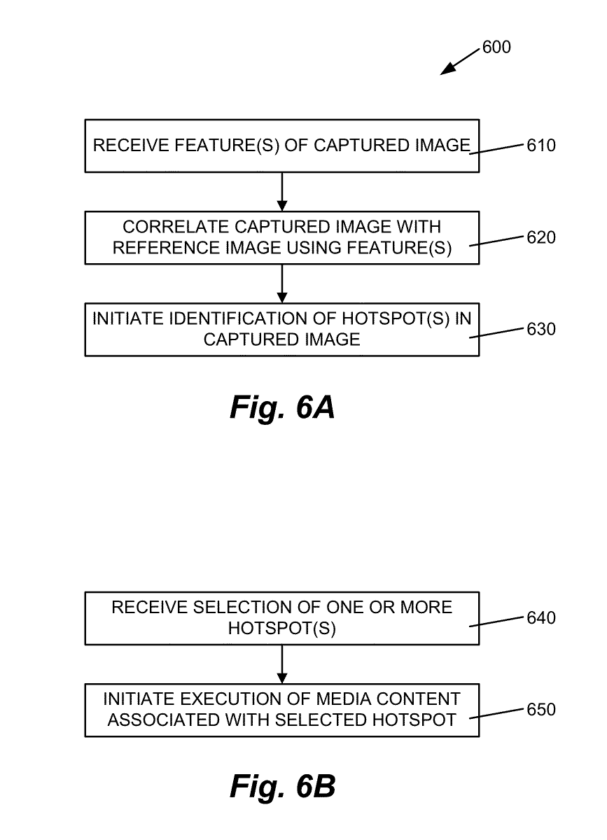

FIGS. 6A and 6B are flow diagrams illustrating one example of a method 600 of distributing media content 20. Method 600 represents one example of dynamic media content distribution with content distribution system 10, including interactions from a perspective of content distribution server 40 and a source of media content 20.

With reference to FIG. 6A, at 610, one or more features of captured image 70 are received. Features of captured image 70 are received, for example, at indexing structure 44 of content distribution server 40. As such, at 620, captured image 70 is correlated or matched with a reference image 60 using, for example, the one or more features of captured image 70.

At 630, with captured image 70 correlated or matched to a reference image 60, identification of active or dynamic regions 62 of reference image 60 in captured image 70 is initiated. More specifically, identification of active or dynamic regions 62 of reference image 60 in captured image 70 as hotspots 72 is initiated. In one example, a location of active or dynamic regions 62, is communicated to mobile device 30 such that active or dynamic regions 62 are displayed as hotspots 72 with display of captured image 70 by mobile device 30.

With reference to FIG. 6B, at 640, with hotspots 72 displayed with captured image 70, selection of one or more hotspots 72 is received. Selection of one or more hotspots 72 is received from mobile device 30 in response, for example, to a touch of a hotspot 72 on display device 34 of mobile device 30. Accordingly, at 650, execution of media content 20, as associated with the selected hotspot 72, is initiated. More specifically, media content 20, as associated with the selected hotspot 72, is communicated to media device 30 for execution by media device 30.

Printed materials such as books, magazines, reports, and marketing collateral, among others, often are created from content in digital form. While it may be feasible to include static content (e.g., text, photos, and illustrations) in such printed materials, to include dynamic media content (e.g., audio, video, 3-D models, and/or animation, among others) in such printed materials may be difficult. Thus, such dynamic media content may be omitted when prints are created from digital content. Moreover, the static content may lack any direct mapping to the more dynamic media content. Implementation of the present disclosure can create a link between the static content and the more dynamic media content.

The methods and systems of the present disclosure may provide a more compelling and richer interactive media experience directly from traditional printed materials. In contrast to existing techniques, the printed content (e.g., a greeting card, photobook, etc) itself, when imaged, for example, by an image capture device of a mobile device, serves as a visual trigger to an interactive interface where the user can select (i.e., touch or click) regions of interest for more information.

One application of dynamic media content distribution, as illustrated and described herein, includes linking to on-line media content from a printed magazine. For example, a printed magazine may include a “teaser” page including a summary or summaries of additional, full content available on the website of the magazine. By capturing an image of the “teaser” page (i.e., static media content) with a mobile device, associated “hotspots” of the “teaser” may be highlighted with the display of the captured image of the “teaser” page on the mobile device. As such, selection of a “hotspot” (i.e., user touch of or within the hotspot on a touchscreen display of the mobile device) directs the mobile device to a specified URL for the additional content.

Another application of dynamic media content distribution, as illustrated and described herein, includes “wall paper recognition.” Wall paper recognition includes, for example, customizable wall décor with a plurality of images distributed thereon. As such, wall paper recognition uses local features and feature descriptors to recognize at which image a digital camera is pointing, regardless of how a photograph of the image is acquired (e.g., regardless of whether an actual photograph of the image is taken and saved, or whether a real-time image is registered on the view screen of the digital camera, among other possibilities).

Accordingly, wall paper recognition can correlate or match the image, at which the digital camera is pointed, with a corresponding image saved in a memory database (e.g., an image of a poster with a plurality of images that can be affixed to the wall). Such a correlation or match can, for example, enable dynamic media content (e.g., video and/or audio) associated with a corresponding image to start playing. One example is a music wall where pointing a camera of a mobile device at one image representing a particular song or music album among a plurality of images (e.g., representing other songs or music albums) causes the correlated or matched song or music album to start playing.

Another application of dynamic media content distribution, as illustrated and described herein, includes an image-based “game.” For example, a first user associates a secret message (i.e., dynamic media content) with a region (i.e., “hotspot”) of a digital image (thereby creating a reference image). A print (i.e., static media content) of the digital image is created by or given to a second user (e.g., friend/family). When the second user views the printed image with a mobile device (e.g., smartphone), a correlation of the printed image with the digital image is established, as described above, and the digital image is displayed into the corresponding geometry of the physical print. Then, the digital image is changed (e.g., a flag in the image disappears). If the user spots the change, he/she can touch the area of change (i.e., “hotspot”), thereby invoking display of the secret message.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A method of distributing media content, comprising:
capturing an image of a static media content;
detecting at least one feature in the image;
seeking a correlation of the image to a reference image using the at least one feature; and
identifying at least one region of dynamic media content of the reference image in the image of the static media content.

2. The method of claim 1, wherein the static media content comprises at least one of text, a photograph, an illustration, a still image, and a video frame, and wherein the dynamic media content comprises at least one of audio, video, and a uniform resource locator (URL) to an Internet source.

3. The method of claim 1, wherein capturing the image of the static media content comprises capturing the image with an image capture device of a mobile device, and wherein identifying the at least one region of dynamic media content comprises highlighting the at least one region while displaying the image of the static media content on a display of the mobile device.

4. The method of claim 3, further comprising:
receiving a selection of the at least one region of dynamic media content at the mobile device; and
initiating the dynamic media content with the mobile device.

5. The method of claim 3, wherein the mobile device comprises at least one of a smartphone and a tablet computer.

6. A method of distributing media content, comprising:
receiving at least one feature of a captured imaged;
correlating the at least one feature to at least one feature of a reference image; and
initiating identification of at least one region of dynamic media content of the reference image in the captured image.

7. The method of claim 6, wherein the dynamic media content comprises at least one of audio, video, and a uniform resource locator (URL) to an Internet source.

8. The method of claim 6, wherein receiving the at least one feature of the captured image comprises receiving the at least one feature from a mobile device.

9. The method of claim 8, wherein initiating identification of the at least one region of dynamic media content comprises initiating highlighting of the at least one region in the captured image at the mobile device.

10. The method of claim 8, wherein the mobile device comprises at least one of a smartphone and a tablet computer.

11. A system to distribute media content, comprising:
a database to store a plurality of reference images each including at least one region of dynamic media content; and
an indexing structure to correlate at least one feature of a captured image with at least one feature of one of the reference images and initiate identification of the at least one region of dynamic media content in the captured image.

12. The system of claim 11, wherein the dynamic media content comprises at least one of audio, video, and a uniform resource locator (URL) to an Internet source.

13. The system of claim 11, further comprising:
the indexing structure to receive the at least one feature of the captured image from a mobile device and return an indication of the at least one region of dynamic media content to the mobile device for display with the captured image by the mobile device.

14. The system of claim 13, wherein selection of the at least one region of dynamic media content at the mobile device initiates the dynamic media content.

15. The system of claim 13, wherein the mobile device comprises at least one of a smartphone and a tablet computer.
